(19) United States
(12) Patent Application Publication
(10) Pub. No.: US 2014/0340264 A1
(43) Pub. Date: Nov. 20, 2014

(54) ANTENNA STRUCTURE

(71) Applicant: LOROM INDUSTRIAL CO., LTD., Taipei City (TW)

(72) Inventor: Bing Hao ZENG, Taichung City (TW)

(73) Assignee: LOROM INDUSTRIAL CO., LTD., Taipei City (TW)

(21) Appl. No.: 13/961,588

(22) Filed: Aug. 7, 2013

(30) Foreign Application Priority Data
May 17, 2013 (TW) 102209202

(51) Int. Cl. H01Q 1/38

(52) U.S. Cl. CPC H01Q 1/38
USPC 343/700 MS

(57) ABSTRACT

Disclosed is an antenna structure, comprising a substrate, an antenna circuit disposed on at least one surface of the substrate, and a circuit unit disposed on the same surface of the substrate having the antenna circuit disposed thereon, or another surface opposite to the surface where the antenna circuit is disposed, wherein the circuit unit at least includes a signal receiving element connected to one end of the antenna circuit, thereby integrating the antenna circuit and the circuit unit on a single substrate and enhancing signal reception.

### BACKGROUND OF THE INVENTION

1. Field of the Invention

The present invention relates to antenna structures, and, more particularly, to an antenna structure for receiving and transmitting wireless signals.

2. Description of Related Art

An antenna structure is an essential device for receiving different wireless signals such as radio frequency, amplitude modulation frequency, Global Positioning Systems (GPS), Global Systems for Mobile Communications (GSM), wireless network (Wi-Fi), and for subsequent signal processing.

An antenna body may have a variety of shapes and structures in order to adapt to different sizes of wireless signal transmission/reception devices or ambient environments to obtain a greater signal gain. For instance, a conventional antenna body for receiving wireless signals of radio frequency and amplitude modulation frequency typically uses a retractable metal rod or a winding magnet wrapped in a paint-coated wire as a reception antenna body for signal reception. However, when such an antennas is applied for vehicle use, the fixed or retractable metallic antenna body is susceptible to collisions and impacts due to lack of bending flexibility.

To resolve the foregoing technical problem, antenna bodies made of spring structures, or metal antenna bodies encapsulated by an elastic material have been used in prior techniques in order to increase flexibility of the antenna body.

Moreover, traces having varying widths coated with copper or gold on the substrate surface or the substrate inner layer of printed circuit boards (PCB) have also been used in prior techniques in order to reduce the overall size of the antenna body and to use traces as a wireless antenna body for wirelessly signal reception.

While using metal conductive wires as an antenna body in prior techniques can facilitate size reduction, it would necessitate the connection with a circuit unit for purposes of receiving, processing and/or outputting signals. Besides, the overall size of the wireless signal reception/transmission processing device cannot be effectively and desirably reduced in certain particular applications that have greater and stricter demands for a compact size and shape of antennas to satisfy the outlook, visual effect, such as a fin-shaped. antenna for vehicle use. On the other end, not only the antenna body needs to be streamlined but also one has to take the effect of signal reception into proper consideration in order to overcome technical problems that may arise consequently.

### SUMMARY OF THE INVENTION

In view of the drawbacks associated with the prior techniques, the invention proposes a novel antenna structure, which comprises a substrate, an antenna circuit disposed on at least one surface of the substrate, and a circuit unit comprised of at least a signal receiving element connected to one end of the antenna circuit, the circuit unit disposed on the surface of the substrate having the antenna circuit disposed thereon, or another surface opposite to the surface where the antenna circuit is disposed.

In one preferred embodiment of the present invention, the antenna circuit is constituted by a plurality of parallel line sections and a plurality of connecting line sections, wherein each of the connecting line sections respectively connects to two adjacent ones of the parallel line sections, the connecting line sections can form a straight line, a curving line or in the shape of an acute angle, and the antenna circuit has two ends and one of the two ends is connected to the signal receiving element.

In one preferred embodiment of the present invention, the surface of the substrate having the antenna circuit and/or the circuit unit disposed thereon is in the shape of a polygon.

In one preferred embodiment of the present invention, the surface of the substrate having the antenna circuit and/or the circuit unit disposed thereon is in the shape of a triangle, a trapezoid or a pentagon.

In one preferred embodiment of the present invention, the surface of the substrate having the antenna circuit and/or the circuit unit disposed thereon is in the shape of a pentagon, and the pentagon has at least a pair of parallel side lines.

In one preferred embodiment of the present invention, the substrate is further formed with at least a through hole.

In one preferred embodiment of the present invention, the circuit unit further includes an amplifier and/or a signal output element.

In one preferred embodiment of the present invention, the antenna structure further comprises a housing that covers the substrate, the antenna circuit and the circuit unit therein.

In one preferred embodiment of the present invention, the antenna circuit occupies more than a half of the surface of the substrate.

Compared to prior techniques, the antenna structure of the invention is characterized by integrating the antenna circuit and the circuit unit on the same or opposite surface of a single substrate to thereby reduce the overall size of the antenna device. Further, the antenna circuit may also be disposed on the surface of the substrate as required to enhance the range and effect of signal reception.

### BRIEF DESCRIPTION OF THE DRAWINGS

The present invention can be more fully understood by reading the following detailed description of the preferred embodiments, with reference made to the accompanying drawings, wherein:

FIG. 1 illustrates a schematic view of the antenna structure in accordance with a first preferred embodiment of the present invention; and

FIG. 2 illustrates a schematic view of the antenna structure in accordance with a second preferred embodiment of the present invention; and

### DETAILED DESCRIPTION OF THE PREFERRED EMBODIMENTS

The following illustrative embodiments are provided to illustrate the disclosure of the present invention, these and other advantages and effects can be understood by persons skilled in the art after reading the disclosure of this specification. Note that the structures, proportions, sizes depicted in the accompanying figures merely serve illustrate the disclosure of the specification to allow for comprehensive reading without a limitation to the implementation or applications of the present invention, and does not constitute any substantial technical meaning.

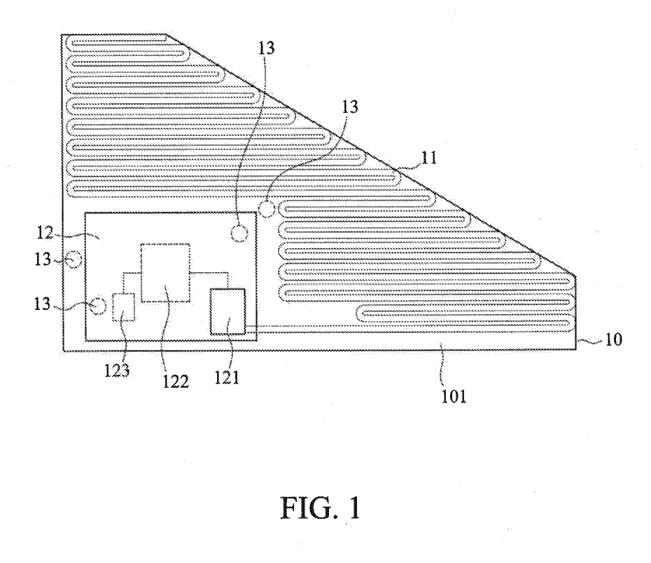

Referring to FIG. 1, a schematic view of the antenna structure in accordance with a first preferred embodiment of the present invention is illustrated. As shown, the antenna structure of this invention comprises a substrate 10, an antenna circuit 11 and a circuit unit 12. The substrate 10 may include, but is not limited to, a conventional FR4 substrate, a ceramic substrate or CEM (Composite Epoxy Material) substrates of different specifications. In this embodiment, the substrate 10 for disposing the antenna circuit 11 thereon is in the shape of a pentagon, and more specifically; the substrate 10 is constituted by two sets of parallel long and short sides, as well as a hypotenuse connecting the two parallel short sides. Note that in other embodiment, the substrate 10 for disposing the antenna circuit 11 thereon may include different shapes such as a triangle, a trapezoid, a square, a rectangle or any other polygon.

The antenna circuit 11 may be disposed on the surface of the substrate 10 by known techniques of electroplating or etching, therefore the detailed descriptions thereof will be omitted for brevity. As shown this embodiment, the antenna circuit 11 may be constituted by a plurality of parallel line sections and a plurality of connecting line sections, and each of the connecting line sections is respectively connected to two adjacent ones of the parallel line sections. in addition, the plurality of parallel line sections may have different lengths according to the shape of the substrate, and also the width of the antenna circuit 10 may be adjusted according to the actual requirement. More specifically, in this embodiment, the plurality of parallel line sections and connecting line sections may constitute the antenna circuit 11 having two ends.

Preferably, the connecting line sections may be in a bending shape, but in other embodiment, the connecting line sections may also be two vertical straight lines adjacent to one another, or in the shape of an acute angle.

Moreover, since the surface and shape of the antenna circuit 11 would affect the ranges and effects of reception of wireless signals, therefore, preferably in this embodiment, the antenna circuit 11 occupies more than a half of the surface of the substrate 10, Note that the occupying surface may be adjusted according to the actual requirement.

In this embodiment, the substrate 10 may further include four through holes 13 which are adapted to fasten the antenna structure with other constituent elements for securing purposes.

The circuit unit 12 includes at least a signal receiving element 21 connected to one end of the antenna circuit 11, and may further include elements such as an amplifier 122 and a signal output element 123. Specifically, the circuit unit 12 may optionally be disposed on the surface 101 (as shown in FIG. 1) of the antenna circuit 11, moreover, the circuit unit 12 may be optionally disposed on the other surface (not shown) of the antenna circuit 11 opposite to the surface 101. As described above, the antenna circuit 11 has two ends and one end thereof is connected to a feed-in end of the signal receiving element 121.

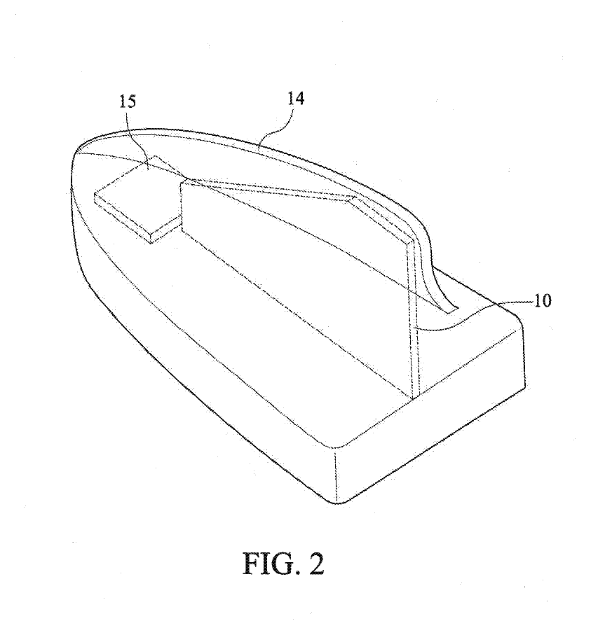

Referring to FIG. 2, a schematic view of the antenna structure in accordance with a second preferred embodiment of the present invention is depicted. As shown in this embodiment, the antenna structure may further include a housing in addition to the elements disclosed in the previous embodiment. The housing 13 is adapted to fully cover the substrate 10, the antenna circuit 11 and the circuit unit 12, or can only partially cover the foregoing elements as required. The housing can be, but not limited to, the shape of a fin.

Same as those described in the first embodiment, the substrate 10, surfaces of the antenna circuit 11 and the circuit unit 12 in this embodiment are also in the shape of a pentagon, therefore, these elements are all or partially accommodated in the housing 14, and one of the short side may provide more space in the housing 14 to thereby include additional elements such as a GPS module or other electronic units, modules or devices as required.

Summarizing the above, the invention is characterized by integrating the antenna circuit and the circuit unit on the same or opposite surface of a single substrate so as to reduce the overall size, and moreover, the antenna circuit may also be disposed on the surface of the substrate as required to enhance the range and effect of signal reception.

It will be understood that the invention may be embodied in other specific forms without departing from the spirit or central characteristics thereof, The present examples and embodiments, therefore, are to he considered in all respects as illustrative and not restrictive, and the invention is not to be limited to the details given herein.

What is claimed is:

1. An antenna structure, comprising
a substrate;
an antenna circuit disposed on at least one surface of the substrate, and
a circuit unit comprised of at least a signal receiving element connected to one end of the antenna circuit, the circuit unit being disposed on the surface of the substrate where the antenna circuit is disposed, or another surface opposite to the surface where the antenna circuit is disposed.

2. The antenna structure claimed in claim 1, wherein the antenna circuit is constituted by a plurality of parallel line sections and a plurality of connecting line sections, wherein each of the connecting line sections respectively connects to two adjacent ones of the parallel line sections.

3. The antenna structure claimed in claim 2, wherein the connecting line sections can form a straight line, a curving line or in the shape of an acute angle.

4. The antenna structure claimed in claim 2, wherein the antenna circuit has two ends and one of the two ends is connected to the signal receiving element.

5. The antenna structure claimed in claim 1, wherein the surface of the substrate having the antenna circuit and/or the circuit unit disposed thereon is in the shape of a polygon.

6. The antenna structure claimed in claim 1, wherein the surface of the substrate having the antenna circuit and/or the circuit unit disposed thereon is in the shape of a pentagon.

7. The antenna structure claimed in claim 6, wherein the pentagon has at least a pair of parallel side lines.

8. The antenna structure claimed in claim 1, wherein the substrate is further with at least a through hole.

9. The antenna structure claimed in claim 1, wherein the circuit unit further includes an amplifier and/or a signal output element.

10. The antenna structure claimed in claim 1, further comprising a housing that at least partially covers the substrate, the antenna circuit and the circuit unit.

11. The antenna structure claimed in claim 1, wherein the antenna circuit occupies more than a half surface of the substrate.
